(19) United States
(12) Patent Application Publication
(10) Pub. No.: US 2026/0158453 A1
(43) Pub. Date: Jun. 11, 2026

(54) METHOD FOR DETERMINING HYDRATION NUMBER OF SALT IONSPERMEATING THROUGH POLYAMIDE SEPARATION MEMBRANES

(71) Applicant: TONGJI UNIVERSITY, SHANGHAI (CN)

(72) Inventors: LI WANG, SHANGHAI (CN); ZHIWEI WANG, SHANGHAI (CN); SHENG WANG, SHANGHAI (CN); YUN GUO, SHANGHAI (CN)

(73) Assignee: TONGJI UNIVERSITY, SHANGHAI (CN)

(21) Appl. No.: 19/403,340

(22) Filed: Nov. 28, 2025

(30) Foreign Application Priority Data
Dec. 6, 2024 (CN) 2024117827123

(51) Int. Cl. B01D 71/56; B01D 61/02; B01D 61/58; G01N 27/333

(52) U.S. Cl. CPC B01D 71/56; B01D 61/027; B01D 61/58; G01N 27/3335; B01D 2313/345

(57) ABSTRACT

The present invention provides a method for determining the hydration number of salt ions during permeation through a polyamide separation membrane. The method comprises: peeling off the polyester backing layer and dissolving the polysulfone support layer of the polyamide separation membrane to obtain an active layer of the polyamide separation membrane; coating the active layer onto a counter electrode platinum sheet and a Au sensor; placing the counter electrode platinum sheet and the Au sensor into an EQCM-D module and connecting to an electrochemical workstation via a three-electrode system, then respectively introducing ultrapure water and a salt solution of known concentration until equilibrium is reached, and applying a constant voltage after equilibrium, while recording the changes in frequency and current throughout the process to quantitatively determine the hydration number of salt ions during permeation through the polyamide separation membrane.

### TECHNICAL FIELD

The present invention relates to the field of membrane technology, and more particularly, to a method for determining the number of hydration water molecules carried by salt ions during permeation through a polyamide separation membrane.

### BACKGROUND

Dissolved ions capture water molecules through electrostatic interactions to form a hydration shell composed of hydrated ions. Within the hydration shell, water molecules are connected via hydrogen bonds. Due to the differences in ionic properties—such as ion size and charge density—different ions exhibit distinct hydration structures (including the size and configuration of hydrates). The transport of hydrated ions through (sub-)nanometer channels is ubiquitous in nature as well as in many industrial and biomedical applications. At the (sub-)nanoscale, interactions between salt ions and the pore walls are amplified, such that the behaviors and properties of ions under these confined conditions differ significantly from those in bulk solution. Since membrane pores are generally smaller than hydrated ions, dehydration of ions inevitably occurs during membrane permeation, which further affects the selective transport of different ions. The degree of dehydration depends specifically on the hydration energy of the ion. Thus, for ions with the same charge and similar hydrated diameters, dehydration becomes a key factor in determining their selective transport across the membrane. By optimizing the solution chemistry and designing membranes with a focus on dehydration-dominated transport, it is possible to amplify differences in ion hydration structures, thereby improving ion selectivity. This research has important implications for improving the ion selectivity of membrane separations for selective resource recovery and efficient desalination technologies, such as seawater desalination, lithium extraction, recovery of valuable metals, and separation of hazardous metal ions.

Partial dehydration of ions occurs as they partition into the membrane, reducing the hydration number of ions compared to their bulk phase. However, the precise mechanisms governing the dehydration remains elusive. A major hurdle limiting our understandings about the dehydration mechanisms is to quantify the hydration number of salt ions. Most studies on dehydration mechanisms in the past have relied on theoretical simulations and lack analytical characterization techniques. Therefore, a systematic investigation of the hydration number during ion-selective transport is required to comprehensively analyze the transmembrane mechanism. This would facilitate the design of solute-solute selective membranes required for precise separation, thereby improving energy efficiency and process performance. There is an urgent need to develop a method capable of analytical determination of the number of hydration water molecules carried by salt ions during their permeation through a polyamide separation membrane, in order to elucidate the dehydration behavior of salt ions and overcome the limitations of existing technologies.

### SUMMARY

To solve the above-mentioned technical problem, the present invention provides a method for determining the number of hydration water molecules carried by salt ions during permeation through a polyamide separation membrane. The method disclosed in this invention features high sensitivity and broad applicability, and enables quantitative characterization of the hydration number of salt ions under various aqueous chemical conditions during permeation through a polyamide separation membrane. This provides a novel strategy and approach for elucidating the underlying mechanisms of salt ion transmembrane mass transfer.

The objective of the present invention is to provide a method for determining the number of hydration water molecules carried by salt ions during permeation through a polyamide separation membrane, comprising the following steps:
S1. Peeling off the polyester backing layer and dissolving the polysulfone support layer to obtain the active layer of the polyamide separation membrane;
S2. Coating the active layer of the polyamide separation membrane obtained in step S1 onto the counter electrode platinum sheet and the QCM-D Au sensor chip;
S3. Placing the counter electrode platinum sheet and gold sensor obtained in step S2 into an EQCM-D module, and connecting the system to an electrochemical workstation via a three-electrode setup. Water and salt solution are introduced respectively until equilibrium is reached. After equilibrium, a constant voltage is applied, and the changes in frequency and current throughout the process are recorded to quantitatively determine the hydration number of salt ions during permeation through the polyamide separation membrane.

Specifically, the method of the present invention includes: Peeling off the polyester backing layer and dissolving the polysulfone support layer of the polyamide separation membrane; coating the active layer of the polyamide separation membrane, from which the polyester backing layer and the polysulfone support layer have been removed, onto a quartz crystal microbalance Au sensor (QCM-D Sensor 301) and the counter electrode platinum sheet of the electrochemical quartz crystal microbalance module (EQCM-D); connecting the assembled EQCM-D module to an electrochemical workstation via a three-electrode setup and placing it on the quartz crystal microbalance device (QCM-D). Ultrapure water and salt ion solution are introduced respectively to reach equilibrium, and frequency changes are recorded. A constant voltage is applied using the electrochemical workstation, and the current and frequency changes are recorded to quantitatively determine the hydration number of salt ions during permeation through the polyamide separation membrane.

In some embodiments of the present invention, in step S1, the polyamide separation membrane is selected from nanofiltration membranes, reverse osmosis membranes, or self-fabricated membranes.

In some embodiments of the present invention, step S1 further includes impurity removal from the polyamide separation membrane: the polyamide separation membrane is soaked in an isopropanol solution and then rinsed with ultrapure water to remove surface impurities and the protective layer. After drying, the polyester backing layer is peeled off.

Furthermore, the isopropanol solution has a concentration of 10-50% v/v;
the soaking time is 30-60 min;
and the membrane is rinsed at least three times.
In some embodiments of the present invention, in step S2, the method of coating the polyamide separation membrane active layer onto the counter electrode platinum sheet and the Au sensor comprises: soaking the polyamide separation membrane active layer in an organic solvent, placing the counter electrode platinum sheet and Au sensor at the bottom of the polyamide separation membrane active layer, and then retrieving the counter electrode platinum sheet and Au sensor now coated with the active layer of the polyamide separation membrane.

In some embodiments of the present invention, the organic solvent is selected from one or more of N,N-dimethylformamide, chloroform, or dimethyl sulfoxide.

In some embodiments of the present invention, step S2 further includes cleaning the counter electrode platinum sheet and the Au sensor: using alcohol wipes to remove excess polyamide separation membrane active layer from the back surfaces of the counter electrode platinum sheet and Au sensor, and puncturing the polyamide separation membrane active layer at the flow channel of the counter electrode platinum sheet.

In some embodiments of the present invention, in step S3, the calculation formulas for the hydration number of salt ions during permeation through the polyamide separation membrane are as follows:

$$Δ {m}_{i} = \frac{- C * Δ f * 1.13}{n} ,$$

$${Q}_{i} = {Q}_{t} - It ,$$

$$M {W}_{i}^{′} = \frac{Δ {m}_{i} * F}{{Q}_{i}} ,$$

$${N}_{i} = \frac{M {W}_{i}^{′} - M {W}_{i}}{M {W}_{{H}_{2} O}} ,$$

The mass change Δmᵢ of hydrated salt ions permeating through the polyamide separation membrane is defined as the product of the crystal constant C and the frequency change Δf. The relative atomic mass MW′ᵢ of the hydrated salt ions is defined as the ratio of the product of Δmᵢ and the Faraday constant F to the charge quantity Qᵢ. The hydration number Nᵢ is defined as the difference between MW′ᵢ and the relative atomic mass MWᵢ of the bare salt ion, divided by the relative molecular mass MW_{H}_{₂}_{O}—of water.

n=5, C=17.7 ng/(Hz·cm²), and Δf is obtained by subtracting the frequency before applying the constant voltage from the frequency after applying it. F=96485 C/mol, Qᵢ, is the amount of charge required for ion i to enter the polyamide separation membrane, which equals the total charge Qₜ transferred during the constant voltage process minus the charge It resulting from the electrical double layer. Qₜ is obtained by integrating the I-t curve recorded by the electrochemical workstation, where I is the current at system stability and t is the time corresponding to system stability. MWᵢ and MW′ᵢ are the relative atomic masses of the non-hydrated and hydrated forms of ion i, respectively. Nᵢ is the hydration number of ion i during permeation through the polyamide separation membrane.

In some embodiments of the present invention, in step S3, the method for ensuring full adsorption equilibrium of salt ions on the polyamide separation membrane includes, for example: when the salt ion concentration is 100 mM, the peristaltic pump flow rate is 30 μL/min, and the equilibrium time ranges from 0.5 to 2 hours.

In some embodiments of the present invention, in step S3, the pH value of the salt solution ranges from 3 to 11, the salt solution is a single-salt solution, and the ion concentration ranges from 100 mmol/L to 1000 mmol/L.

In some embodiments of the present invention, in step S3, the method of pH adjustment is acid-base titration, and the pH value is characterized using a Leici PHSJ-3F laboratory pH meter.

In some embodiments of the present invention, in step S3, both water and salt solutions are run for 0.5 to 2 hours to reach a stable equilibrium.

Specifically, in step S4, the water is ultrapure water produced by a Milli-Q IQ 7000 ultrapure water system, with a tested conductivity of less than 0.2 μS/cm.

In some embodiments of the present invention, in step S3, the hydration number of anions or cations is determined by controlling the polarity of the applied constant voltage. Applying a negative voltage is used to measure the hydration number of cations, while applying a positive voltage is used to measure the hydration number of anions.

In some embodiments of the present invention, in step S3, the cation in the salt solution is selected from one of lithium, sodium, potassium, calcium, or magnesium, and the anion is selected from chloride or sulfate ions.

Compared with the prior art, the above technical solution of the present invention has the following advantages:

The present invention adopts a technique based on a quartz crystal microbalance and an electrochemical workstation to quantitatively characterize the hydration number of salt ions during permeation through a polyamide separation membrane. By calculating the mass difference of the polyamide separation membrane before and after equilibrium under a constant voltage with the salt solution, and the transferred charge quantity, the method accurately quantifies the hydration number of salt ions during their permeation through the membrane. This method is simple to operate, real-time, and intuitive, and can be widely applied to thin-film composite reverse osmosis membranes, nanofiltration membranes, and self-fabricated membranes. It provides an important analytical tool for determining the hydration number of salt ions during permeation through a polyamide separation membrane.

### BRIEF DESCRIPTION OF THE DRAWINGS

To facilitate a clearer understanding of the present invention, the following provides a more detailed description of the invention based on specific embodiments and in conjunction with the accompanying drawings, in which:

FIG. 1 is a schematic diagram of the process flow for the method used to determine the number of hydration water molecules carried by salt ions during permeation through a polyamide separation membrane, as illustrated in the embodiment;

FIG. 2 is a schematic diagram showing the frequency change under a constant voltage of −0.3 V with 100 mM Na⁺ in Embodiment 1;

FIG. 3 is a schematic diagram showing the current change under a constant voltage of −0.3 V with 100 mM Na⁺ in Embodiment 1;

FIG. 4 is a schematic diagram of the measured hydration numbers of Li⁺ and Na⁺ during permeation through the NF90 polyamide separation membrane, as illustrated in the embodiment.

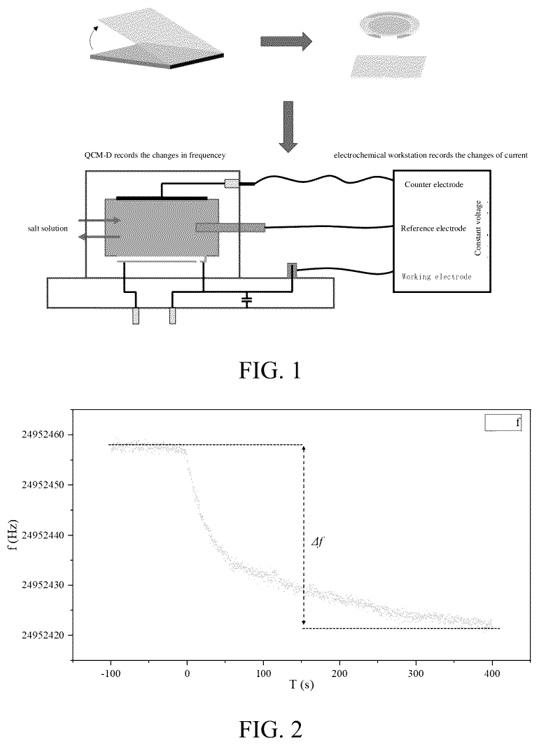

### DETAILED DESCRIPTION

The present invention will be further described below in conjunction with the accompanying drawings and specific embodiments to facilitate a better understanding and implementation by those skilled in the art. However, the embodiments cited are not intended to limit the scope of the present invention.

The objective of the present invention is to provide a method for determining the number of hydration water molecules carried by salt ions during permeation through a polyamide separation membrane, comprising the following steps:
S1. Peeling off the polyester backing layer and dissolving the polysulfone support layer of the polyamide separation membrane, leaving only the active layer;
S2. Evenly coating the active layer of the polyamide separation membrane, obtained by removing the polyester backing layer and the polysulfone support layer in step S1, onto the counter electrode platinum sheet and the QCM-D Au sensor;
S3. Placing the counter electrode platinum sheet and Au sensor obtained in step S2 in a ventilated area until completely dry; and
S4. Placing the dried counter electrode platinum sheet and Au sensor from step S3 into the EQCM-D module, connecting it to an electrochemical workstation via a three-electrode system, and respectively introducing ultrapure water and a salt solution of known concentration until equilibrium is reached. After equilibrium, a known constant voltage is applied, and the changes in frequency and current throughout the process are recorded to quantitatively determine the hydration number of salt ions during permeation through the polyamide separation membrane.

### Embodiment 1

This embodiment provides a method for determining the hydration number of Na⁺ ions during permeation through an NF90 polyamide separation membrane. The specific steps are as follows:
(1) The commercial NF90 polyamide separation membrane was soaked in 25% v/v isopropanol for 60 minutes, then rinsed three times with ultrapure water. After rinsing, the polyester backing layer of the NF90 polyamide separation membrane was peeled off. The membrane was then immersed in an N,N-dimethylformamide solution to remove the polysulfone support layer, thereby obtaining the active layer of the NF90 polyamide separation membrane.
(2) The counter electrode platinum sheet and Au sensor were placed beneath the active layer of the NF90 polyamide separation membrane, which had been soaked in N,N-dimethylformamide. The counter electrode platinum sheet and Au sensor coated with the membrane's active layer were retrieved and placed in a fume hood to dry completely. After drying, alcohol wipes were used to remove the excess NF90 polyamide active layer from the back surfaces of the platinum sheet and Au sensor. A needle was used to puncture the NF90 polyamide membrane at the flow channel of the counter electrode platinum sheet.
(3) A 100 mM NaCl solution with a pH of 5.70 was prepared.
(4) The counter electrode platinum sheet and Au sensor obtained in step (2) were placed into the EQCM-D module and connected to an electrochemical workstation. The peristaltic pump speed was set to 30 μL/min. Ultrapure water was introduced for 1 hour until the frequency stabilized, followed by the 100 mM NaCl solution from step (3) for 30 minutes until frequency stabilization. After stabilization, a constant voltage of −0.3 V was applied for 10 minutes. The frequency and current changes during the entire process were recorded to quantitatively determine the hydration number of Na+ ions during permeation through the NF90 polyamide separation membrane.
(5) The mass change Δm_{Na}_{⁺} of Na⁺ ions permeating through the polyamide separation membrane is defined as the product of the crystal constant C and the frequency change Δf during the NaCl solution process. The relative atomic mass MW′_{Na}_{⁺} of the hydrated Na⁺ ion is defined as the product of Δm_{Na}_{⁺} and the Faraday constant F divided by the charge quantity Q_{Na}_{⁺}. The hydration number N_{Na}_{⁺} is defined as the difference between MW′_{Na}_{⁺} and the relative atomic mass MW_{Na}_{⁺} of the Na⁺ ion, divided by the relative molecular mass MW_{H2O} of water. The calculation formulas are as follows:

$$Δ {m}_{{Na}^{+}} = \frac{- C * Δ f * 1.13}{n} ,$$

$${Q}_{{Na}^{+}} = {Q}_{t} - It ,$$

$$M {W}_{{Na}^{+}}^{′} = \frac{Δ {m}_{{Na}^{+}} * F}{Q} ,$$

$${N}_{{Na}^{+}} = \frac{M {W}_{{Na}^{+}}^{′} - M {W}_{{Na}^{+}}}{M {W}_{{H}_{2} O}} ,$$

wherein, n=5, C=17.7 ng/(Hz·cm²), and Δf is obtained by subtracting the frequency before the application of the constant voltage from that after the application. F=96485 C/mol. Q_{Na}_{⁺} is the charge required for Na⁺ ions to permeate the NF90 polyamide separation membrane, which is calculated as the total charge transferred Qₜ during the constant voltage application minus the charge It resulting from the electrical double layer. Qₜ is obtained by integrating the I-t curve recorded by the electrochemical workstation. I is the current value corresponding to the stable system, and t is the time corresponding to this stable state. MW_{Na}_{⁺} and MW′_{Na}_{⁺} refer to the relative atomic masses of the non-hydrated and hydrated forms of the Na⁺ ion, respectively. N_{Na}_{⁺} is the hydration number of Na⁺ during permeation through the NF90 polyamide separation membrane.
(6) The calculations yielded the following results under a constant voltage of −0.3 V and at t=400 s with a Na⁺ concentration of 100 mM and pH 5.70: Δm_{Na}_{⁺}=146.0 ng, MW′_{Na}_{⁺}=68.4 g/mol, Qₜ=3.75×10⁻³ C, I=8.86×10⁻⁶ A, Q_{Na}_{⁺}=2.06×10⁻⁴ C, N_{Na}_{⁺}=2.52.

FIG. 2 shows the frequency change diagram under the condition of applying a constant voltage of −0.3 V with 100 mM Na⁺ in this embodiment. As shown in the figure, before applying the constant voltage (with the moment of applying the voltage set as T=0), 100 mM Na⁺ was introduced for approximately 30 minutes until the frequency stabilized. (FIG. 2 indicates the frequency after introducing Na⁺ and achieving stabilization, as well as the frequency change following the application of −0.3V.) After the frequency stabilized, a constant voltage of −0.3V was applied. The frequency was observed to continuously decrease with time, and the frequency change Δf corresponds to a change in mass.

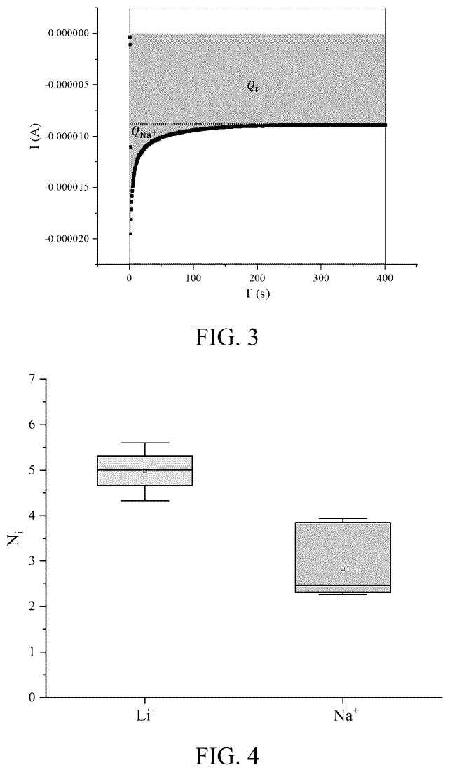

FIG. 3 shows the current change diagram under the condition of applying a constant voltage of −0.3V with 100 mM Na⁺ in this embodiment. As shown in the figure, with the passage of time, the current gradually decreased and eventually reached a stable value. The total charge transferred during the application of the constant voltage is Qₜ, and the stable value corresponds to the charge Iₜ resulting from the electrical double layer. The difference between the two yields the charge O_{Na}_{⁺} required for Na⁺ ions to permeate the polyamide separation membrane.

### Embodiment 2

This embodiment provides a method for determining the hydration number of Li⁺ ions during permeation through an NF90 polyamide separation membrane. The specific steps are as follows:
(1) The commercial NF90 polyamide separation membrane was soaked in 25% v/v isopropanol for 60 minutes, then rinsed three times with ultrapure water. After rinsing, the polyester backing layer was peeled off, and the membrane was immersed in N,N-dimethylformamide to remove the polysulfone support layer, thereby obtaining the active layer of the NF90 polyamide separation membrane.
(2) The counter electrode platinum sheet and Au sensor were placed beneath the active layer of the NF90 polyamide separation membrane soaked in N,N-dimethylformamide. The platinum sheet and Au sensor coated with the active layer were retrieved and placed in a fume hood until completely dry. After drying, excess active layer was wiped from the back surfaces using alcohol wipes, and a needle was used to puncture the membrane at the flow channel of the counter electrode platinum sheet.
(3) A 100 mM LiCl solution with a pH of 5.70 was prepared.
(4) The counter electrode platinum sheet and Au sensor obtained in step (2) were placed into the EQCM-D module and connected to the electrochemical workstation. The peristaltic pump speed was set to 30 μL/min. Ultrapure water was introduced for 1 hour until the frequency stabilized, followed by the 100 mM LiCl solution from step (3) for 30 minutes until stabilization. After stabilization, a constant voltage of −0.3 V was applied for 10 minutes. Frequency and current changes throughout the process were recorded to quantitatively determine the hydration number of Li⁺ ions during permeation through the NF90 polyamide separation membrane.
(5) The mass change Δm_{Li}_{⁺} of Li⁺ ions during permeation through the polyamide separation membrane is defined as the product of the crystal constant C and the frequency change Δf during the LiCl solution process. The relative atomic mass MW′_{Li}_{⁺} of the hydrated Li⁺ ion is defined as the product of Δm_{Li}_{⁺} and the Faraday constant F, divided by the charge Q_{Li}_{⁺}. The hydration number N_{Li}_{⁺} is defined as the difference between MW′_{Li}_{⁺} and the relative atomic mass MW_{Li}_{⁺} of the Li⁺ ion, divided by the relative molecular mass MW_{H2O} of water. The calculation formulas are as follows:

$$Δ {m}_{{Li}^{+}} = \frac{- C * Δ f * 1.13}{n} ,$$

$${Q}_{{Li}^{+}} = {Q}_{t} - It ,$$

$$M {W}_{{Li}^{+}}^{′} = \frac{Δ {m}_{{Li}^{+}} * F}{Q} ,$$

$${N}_{{Li}^{+}} = \frac{M {W}_{{Li}^{+}}^{′} - M {W}_{{Li}^{+}}}{M {W}_{{H}_{2} O}} ,$$

n=5, C=17.7 ng/(Hz·cm²), Δf is obtained by subtracting the frequency before and after the application of constant voltage, F=96485 C/mol, Q_{Li}_{⁺} is the charge required for Li⁺ to permeate the NF90 polyamide membrane, calculated as the total charge Qₜ transferred during the application of constant voltage minus the charge It resulting from the electrical double layer. Qₜ is obtained by integrating the I-t curve recorded by the electrochemical workstation, I is the current at the stable state of the system, t is the time at which the system stabilizes. MW_{Li}_{⁺} and MW′_{Li}_{⁺} are the relative atomic masses of non-hydrated and hydrated Li⁺, respectively. N_{Li}_{⁺} is the hydration number of Li⁺ during permeation through the NF90 polyamide separation membrane.
(6) Under the condition of a constant voltage of −0.3V and t=100 s, with a Li⁺ concentration of 100 mM and pH 5.70, the following values were obtained: Δm_{Li}_{⁺}=44.4 ng, MW′_{Li}_{⁺}=97.4 g/mol, Qₜ=5.74×10⁻⁴ C, I=5.30×10⁻⁶ A, Q_{Li}_{⁺}=4.40×10⁻⁴ C, N_{Li}_{⁺}=5.03.

FIG. 4 is a schematic diagram showing the hydration numbers of Li⁺ and Na⁺ during permeation through the NF90 polyamide separation membrane. As shown in the figure, the average hydration number of Li⁺ is 5.03, and that of Na⁺ is 2.52.

It is evident that the above embodiments are provided solely for the purpose of clearly illustrating the invention and should not be construed as limiting its scope. Those skilled in the art may make various modifications or variations based on the above description. It is neither necessary nor feasible to enumerate all possible embodiments. Any obvious variations or modifications derived therefrom remain within the scope of protection of the present invention.

1. A method for determining the hydration number of salt ions during permeation through a polyamide separation membrane, comprising the following steps:
S1, peeling off the polyester backing layer and dissolving the polysulfone support layer of the polyamide separation membrane to obtain an active layer of the polyamide separation membrane;
S2, coating the active layer obtained in step S1 onto a counter electrode platinum sheet and a Au sensor;
S3, placing the counter electrode platinum sheet and the Au sensor obtained in step S2 into an EQCM-D module and connecting to an electrochemical workstation via a three-electrode system, respectively introducing water and a salt solution until equilibrium is reached, and applying a constant voltage after equilibrium, while recording the changes in frequency and current throughout the process to quantitatively determine the hydration number of salt ions during permeation through the polyamide separation membrane; wherein the calculation formulas for the hydration number of salt ions during the permeation through the polyamide separation membrane are as follows:
$$Δ {m}_{i} = \frac{- C * Δ f * 1.13}{n} ,$$
$${Q}_{i} = {Q}_{t} - It ,$$
$$M {W}_{i}^{′} = \frac{Δ {m}_{i} * F}{{Q}_{i}} ,$$
$${N}_{i} = \frac{M {W}_{i}^{′} - M {W}_{i}}{M {W}_{{H}_{2} O}} ,$$
a mass change Δmᵢ of the hydrated salt ions is defined as the product of the crystal constant C and the frequency change Δf, a relative atomic mass MW′ᵢ of the hydrated salt ions is defined as the ratio of the product of Δmᵢ and the Faraday constant F to a charge quantity Qᵢ; a hydration number Nᵢ is defined as the ratio of the difference between MW′ᵢ and the relative atomic mass MWᵢ of the bare salt ions to a relative molecular mass MW_{H2O} of water;
wherein n=5, C=17.7 ng/(Hz·cm²), Δf is obtained by subtracting a frequency before and after the application of the constant voltage, F=96485 C/mol, Qᵢ is the amount of charge required for ion i to enter the polyamide separation membrane, which equals the total charge Qₜ transferred during the application of the constant voltage minus the charge It caused by the electrical double layer, Qₜ is obtained by integrating an I-t curve recorded by the electrochemical workstation, I is the current corresponding to the stable system, t is the time corresponding to the stable system, MWᵢ and MW′ᵢ are the relative atomic masses of the non-hydrated and hydrated ion i respectively, and Nᵢ is the hydration number of salt ion i during permeation through the polyamide separation membrane.

2. The method for determining the hydration number of salt ions during permeation through a polyamide separation membrane according to claim 1, wherein in step S1, the polyamide separation membrane comprises a nanofiltration membrane, a reverse osmosis membrane, or a self-fabricated membrane.

3. The method for determining the hydration number of salt ions during permeation through a polyamide separation membrane according to claim 1, wherein in step S1, the method further comprises impurity removal from the polyamide separation membrane: soaking the polyamide separation membrane in an isopropanol solution followed by rinsing with ultrapure water to remove surface impurities and the protective layer of the polyamide separation membrane, and then peeling off the polyester backing layer after drying.

4. The method for determining the hydration number of salt ions during permeation through a polyamide separation membrane according to claim 1, wherein step S2 comprises: soaking the active layer of the polyamide separation membrane in an organic solvent, placing the counter electrode platinum sheet and the Au sensor beneath the active layer, and then retrieving the counter electrode platinum sheet and the Au sensor coated with the active layer of the polyamide separation membrane.

5. The method for determining the hydration number of salt ions during permeation through a polyamide separation membrane according to claim 4, wherein the organic solvent is selected from one or more of N,N-dimethylformamide, chloroform, or dimethyl sulfoxide.

6. The method for determining the hydration number of salt ions during permeation through a polyamide separation membrane according to claim 1, wherein in step S2, the method further comprises cleaning the counter electrode platinum sheet and the Au sensor: wiping off excess active layer of the polyamide separation membrane from the back side of the counter electrode platinum sheet and the Au sensor with alcohol wipes, and puncturing the active layer of the polyamide separation membrane at the flow channel of the counter electrode platinum sheet.

7. The method for determining the hydration number of salt ions during permeation through a polyamide separation membrane according to claim 1, wherein in step S3, both the water and the salt solution are run for 0.5 to 2 hours until equilibrium is achieved.

8. The method for determining the hydration number of salt ions during permeation through a polyamide separation membrane according to claim 1, wherein in step S3, the hydration number of anions or cations is determined by controlling the polarity of the applied constant voltage, with negative voltage used for measuring the hydration number of cations and positive voltage used for measuring the hydration number of anions.

9. The method for determining hydration number of salt ions during permeation through a polyamide separation membrane according to claim 1, wherein in step S3, the cation in the salt solution is selected from one of lithium, sodium, potassium, calcium, or magnesium, and the anion is selected from chloride or sulfate ions.
